(19) United States
(12) Patent Application Publication
(10) Pub. No.: US 2007/0169415 A1
(43) Pub. Date: Jul. 26, 2007

(54) Window rail and bracket assembly

(75) Inventor: Anil Jain, Farmington Hills, MI (US)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/340,291

(22) Filed: Jan. 26, 2006

(51) Int. Cl. E05F 11/38

(52) U.S. Cl. 49/348

(57) ABSTRACT

A rail bracket is attached to a window rail with a rivet. The rivet has a non-circular shape, such as an oval shape, which cooperates with an opening in the rail bracket to prevent the rail bracket from rotating relative to the window rail during riveting.

### TECHNICAL FIELD

The subject invention relates to a non-circular rivet configuration that is used for mounting a bracket to a window rail.

### BACKGROUND OF THE INVENTION

Window lifting mechanisms are mounted within vehicle doors to control movement of a window between open and closed positions. Window lifting mechanisms include various components including rails that guide the movement of the window. Traditionally, round rivets are used to attach brackets to the rails. Round openings in the bracket and rail are aligned and the rivet is inserted through the holes and riveted into place.

One disadvantage with this current configuration is that a separate fixture is required to hold the bracket in a proper orientation relative to the rail. If a fixture is not used, the bracket can rotate on the round rivet relative to the rail. If such rotation occurs, the bracket is misaligned, which presents various assembly problems. The use of a separate fixture to hold the bracket increases cost and assembly time.

Thus, there is a need for a mounting interface that does not require a separate fixture, but which reliably holds the bracket in a desired mounting position.

### SUMMARY OF THE INVENTION

A rail bracket is attached to a window rail with a rivet. The rivet is shaped such that rotation of the rail bracket relative to the window rail is prevented without requiring a separate fixture to hold the rail bracket in place. The rivet preferably has a non-circular cross sectional shape, such as an oval shape for example.

The rivet is received within an opening formed in the rail bracket. The opening has a shape that corresponds to that of the rivet, i.e. the opening is non-circular. The rivet cooperates with the opening to prevent the rail bracket from rotating relative to the window rail during riveting.

In one example embodiment, the rivet includes first and second rounded end portions. A pair of straight or flat edges interconnects the first and second rounded end portions. The opening in the rail bracket includes first and second rounded edges that cooperate with the first and second rounded end portions of the rivet, respectively. The opening also includes a pair of straight edges that cooperate with the straight/flat edges of the rivet. This rivet configuration prevents rotation of the rail bracket relative to the window rail.

The subject invention provides an improved method and apparatus for securing a rail bracket to a window rail that eliminates the need for a separate fixture to hold the rail bracket in place relative to the window rail. This reduces cost and assembly time. These and other features of the present invention can be best understood from the following specification and drawings, the following of which is a brief description.

### BRIEF DESCRIPTION OF THE DRAWINGS

FIG. 1 is a perspective view of a window rail and bracket assembly incorporating the subject invention.

FIG. 2 is a perspective view of a rivet as used in the assembly of FIG. 1.

FIG. 3 is a perspective view of a bracket as used in the assembly of FIG. 1.

FIG. 4 is a cross-sectional view of a rivet received within an opening in the bracket.

FIG. 5 is a cross-sectional view of another rivet embodiment.

FIG. 6 is a cross-sectional view of another rivet embodiment.

### DETAILED DESCRIPTION OF THE PREFERRED EMBODIMENT

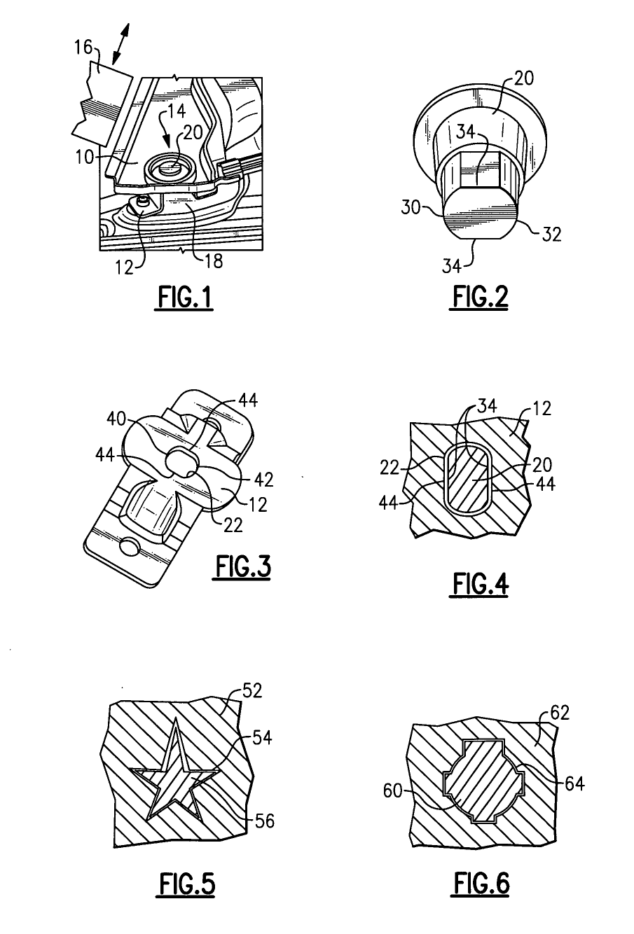

A mounting interface between a rail 10 and a bracket 12, is shown generally at 14 in FIG. 1. The rail 10 comprises a guide component for guiding movement of a window 16 between open and closed positions in a vehicle door as known. Any type of rail configuration can be used. The bracket 12 is mounted to a door structure component 18.

The mounting interface 14 comprises a rivet 20 that is used to secure the bracket 12 to the rail 10. The rivet 20 is shaped such that the bracket 12 can be held fixed relative to the rail 10 during riveting without requiring any additional tooling fixtures.

As shown in FIG. 2, the rivet 20 is defined by a non-circular cross-section that cooperates with an opening 22 in the bracket 12 (FIG. 3). Preferably, the opening 22 corresponds in shape to the shape of the rivet 20.

In the examples shown in FIGS. 2 and 3, both the rivet 20 and the opening 22 have an oval shape. In the example shown, the oval shape of the rivet 20 is defined by a first rounded end portion 30, a second rounded end portion 32 opposite from the first rounded end portion 30, and a pair of straight or flat edge portions 34 that interconnect the first 30 and second 32 rounded end portions.

The oval shape of the opening 22 is defined by a first rounded edge portion 40, a second rounded edge portion 42 opposite from the first rounded edge portion 40, and a pair of straight edges 44 that interconnect the first 40 and second 42 rounded edge portions. The first 30 and second 32 rounded end portions of the rivet 20 are received within the first 40 and second 42 rounded edge portions of the opening 22, respectively.

As shown in FIG. 4, the pair of flat edge portions 34 of the rivet 20 cooperates with the pair of straight edges 44 of the opening to restrict rotation of the bracket 12. Thus, once the rivet 20 is inserted into the opening 22 in the bracket 12, the bracket 12 is prevented from rotating relative to the rail 10, and riveting can be conducted without requiring any additional tooling structures. Further, the bracket 12 is symmetrical such that if the bracket 12 is rotated by 180°, the attachment interface will not change.

FIGS. 5 and 6 show additional embodiments of rivets and brackets. FIG. 5 shows a rivet 50 having a star shape, which secures a bracket 52 to the rail 10. The bracket 52 has an opening 54 that has a star shape corresponding to that of the rivet 50. In order to properly orient the rivet 60 and bracket 62 relative to each other, an index is provided. In the example shown in FIG. 5, the index comprises a point of the star shape that is larger than the other points.

FIG. 6 shows a rivet 60 having a splined configuration, which secures a bracket 62 to the rail 10. The bracket 62 has an opening 64 that corresponds in shape to that of the rivet 60. An index is also provided for this configuration, with one spline being larger than the others. Other non-circular shapes, in addition to the ones shown in FIGS. 4-6, could also be used.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A rail and bracket assembly for supporting a window in a vehicle door comprising:
a rail member;
a bracket member; and
a non-circular rivet that secures said bracket member to said rail member and prevents rotation of said bracket member relative to said rail member during riveting.

2. The rail and bracket assembly according to claim 1 wherein said non-circular rivet comprises an oval rivet.

3. The rail and bracket assembly according to claim 2 wherein said oval rivet includes rounded end portions interconnected to each other with a pair of straight edge portions.

4. The rail and bracket assembly according to claim 1 wherein said bracket member includes an opening having a non-circular shape that corresponds to a shape of said non-circular rivet.

5. The rail and bracket assembly according to claim 4 wherein said non-circular rivet comprises an oval rivet and said opening comprises an oval opening.

6. The rail and bracket assembly according to claim 1 wherein said bracket member is adapted for attachment to a vehicle door structure.

7. A window lifting mechanism comprising;
at least one rail adapted to guide a window between an open position and a closed position;
a bracket including an opening; and
a non-circular rivet that attaches said bracket to said at least one rail, said non-circular rivet cooperating with said opening to prevent rotation of said bracket relative to said at least one rail during riveting.

8. The window lifting mechanism according to claim 7 wherein said non-circular rivet comprises an oval rivet.

9. The window lifting mechanism according to claim 7 wherein said non-circular rivet has a first rounded end portion, a second rounded end portion opposite from said first rounded end portion, and a pair of flat portions interconnecting said first and said second rounded end portions.

10. The window lifting mechanism according to claim 9 wherein said opening comprises a non-circular opening that receives said non-circular rivet, said non-circular opening having first and second rounded edges that cooperate with said first and said second rounded end portions, respectively, and having a pair of straight edges that cooperate with said pair of flat portions to prevent said bracket from rotating relative to said at least one rail.

11. A method for assembling a rail bracket to a rail that guides a window in a vehicle door comprising the steps of:
attaching a rail bracket to a rail with a rivet without requiring a fixture to hold the rail bracket in place relative to the rail.

12. The method according to claim 11 including the step of forming the rivet with a non-circular cross section.

13. The method according to claim 12 wherein the non-circular cross-section comprises an oval cross-section.

14. The method according to claim 12 including the step of preventing rotation of the rail bracket relative to the rail during riveting due to the interaction of the non-circular cross section with a corresponding opening in the rail bracket.

15. The method according to claim 11 including the step of attaching the rail bracket to a vehicle door structure.

16. The method according to claim 11 including the step of supporting a vehicle window for movement relative to the rail.
